(19) United States
(12) Patent Application Publication
(10) Pub. No.: US 2025/0291507 A1
(43) Pub. Date: Sep. 18, 2025

(54) MEMORY DEVICE ACCESS MONITORING UNIT INTERFACE

(71) Applicant: Micron Technology, Inc., Boise, ID (US)

(72) Inventors: Danilo CARACCIO, Milano (IT); Alessandro ORLANDO, Milano (IT); Massimiliano TURCONI, Gorgonzola (IT); Brian HIRANO, Niwot, CO (US)

(21) Appl. No.: 19/056,246

(22) Filed: Feb. 18, 2025

Related U.S. Application Data
(60) Provisional application No. 63/565,425, filed on Mar. 14, 2024.

(51) Int. Cl. G06F 3/06

(52) U.S. Cl. CPC G06F 3/0653; G06F 3/0611; G06F 3/0673

(57) ABSTRACT

In some implementations, a memory system may receive a first indication of one or more memory address ranges to be monitored and a second indication of a memory unit size. The memory system may determine one or more memory units associated with the one or more memory address ranges. The memory system may determine, using an access counter for each memory unit, a quantity of accesses to that memory unit during a monitoring period. The memory system may determine that a corresponding access counter for each memory unit, of a subset of the one or more memory units, satisfies an access threshold. The memory system may add an identifier of, and an indication of the corresponding access counter for, each memory unit, of the subset of the one or more memory units, to a data structure based on determining that the corresponding access counter satisfies the access threshold.

### CROSS-REFERENCE TO RELATED APPLICATION

This patent application claims priority to U.S. Provisional Patent Application No. 63/565,425, filed on Mar. 14, 2024, entitled “MEMORY DEVICE ACCESS MONITORING UNIT INTERFACE,” and assigned to the assignee hereof. The disclosure of the prior application is considered part of and is incorporated by reference into this patent application.

### TECHNICAL FIELD

The present disclosure generally relates to memory devices, memory device operations, and, for example, to a memory device access monitoring unit interface.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL). For example, the memory device may be a CXL compliant memory device and/or may include a CXL interface.

### BRIEF DESCRIPTION OF THE DRAWINGS

FIG. 1 is a diagram illustrating an example system capable of utilizing a memory device access monitoring unit interface.

FIG. 2 is a diagram of an example of a system implementing a memory device access monitoring unit interface.

FIG. 3 is a flowchart of an example method associated with a memory device access monitoring unit interface.

### DETAILED DESCRIPTION

In some memory systems, a controller may track a quantity of accesses (e.g., read operations and/or write operations) to a portion of memory. For example, an access counter (sometimes referred to herein as a hotness counter) may be used by a memory system to determine if a certain portion of memory is accessed relatively frequently, sometimes referred to as being “hot.” In such systems, the hotness counter may be used by the memory system to make informed decisions about data management, such as by maintaining frequently accessed data (e.g., hot data) in a memory location that is easily accessible by the system in order to speed up access times, moving rarely used data (e.g., cold data) to a slower storage, and/or the like.

Although such hotness counters may be useful to the memory system, the hotness counters may be transparent to a connected host system and/or may not provide useful information to the host system. This is because the host system may be unable to configure what portions of a memory are to be monitored, what types of accesses are to be monitored, or how often memory is to be monitored, among other parameters. Moreover, memory systems may have no way of reporting hot portions of a memory to a host system. Accordingly, while tracking accesses to memory may be beneficial for internal memory system operations, hotness counters and/or similar access counters may provide little or no useful information for an attached host system, resulting in inefficient memory operations and thus high power, computing, and storage resource usages.

Some implementations described herein enable an interface (sometimes referred to herein as an access monitoring unit interface) used by a host system to configure one or more access counters used by the host system to retrieve information about hot portions of a memory. More particularly, some implementations enable an interface through which a host system may specify one or more address ranges that are to be monitored by a component of a memory system (sometimes referred to herein as an access monitoring unit) using one or more access counters during a monitoring period (sometimes referred to herein as an epoch). Additionally, or alternatively, the interface may enable certain other configurations for monitoring the one or more address ranges using the one or more access counters, such as by enabling specification of an access threshold, enabling aging of the one or more access counters associated with the address ranges at an end of an epoch, enabling specification of certain types of accesses that are to be tracked (e.g., in a case in which the memory system is a compute express link (CXL) compliant memory system, enabling specification of which CXL.mem requests are to be tracked), and/or enabling specification of an epoch size, among other information. Based on the configuration information received via the access monitoring unit interface and/or other information, the memory system (more particularly, the access monitoring unit of the memory system) may track accesses (e.g., a quantity of specific CXL.mem requests) to specific address ranges at a memory unit granularity, such as by using a corresponding access counter for each memory unit. For each memory unit for which a respective access counter exceeds a configurable access threshold, the memory system may add an identifier of the memory unit and the respective value of the access counter to a data structure (sometimes referred to herein as a hotlist). The host system may access one or more instances of the hotlist, such as via a register or the like, thereby enabling information about which memory units are hot to be shared with the host system. As a result, the access monitoring unit interface may enable improved access tracking mechanisms and/or improved access tracking information sharing between the memory system and the host system, and thus more efficient memory operations and/or reduced power, computing, storage, and other resource consumption by the host system and/or the memory system.

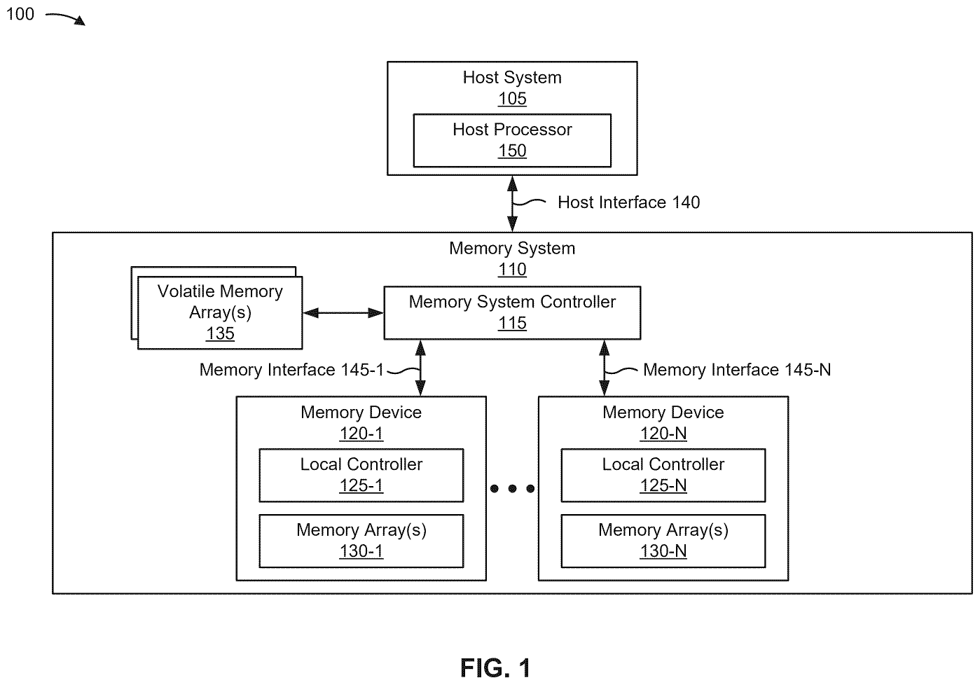

FIG. 1 is a diagram illustrating an example system 100 capable of utilizing a memory device access monitoring unit interface. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110. In some examples, a non-volatile memory and/or a volatile memory array 135 may be allocated as structures used to count accesses to portions of memory (e.g., may be allocated for use as hotness counters). For example, a volatile memory array 135 may include an array of one or more pairs of a memory address a corresponding to a hotness counter.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below).

The memory interface 145 enables communication between the memory system controller 115 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

In some examples, the memory system 110 may be a CXL compliant memory system (sometimes referred to herein as a CXL memory system, a CXL memory device, a CXL memory module, a CXL device, and/or a similar term). CXL is a high-speed CPU-to-device and CPU-to-memory interconnect designed to accelerate next-generation performance. CXL technology maintains memory coherency between the CPU memory space and memory on attached devices, which allows resource sharing for higher performance, reduced software stack complexity, and lower overall system cost. CXL is designed to be an industry open standard interface for high-speed communications. CXL technology is built on the PCIe infrastructure, leveraging PCIe physical and electrical interfaces to provide an advanced protocol in areas such as input/output (I/O) protocol, memory protocol, and coherency interface.

In some examples, such as in examples in which the memory system 110 is a CXL device, the memory system 110 may include a PCIe/CXL interface (e.g., the host interface 140 may be associated with a PCIe/CXL interface), which may be a physical interface configured to connect the CXL memory system and/or the CXL memory device to CXL compliant host devices. In such examples, the PCIe/CXL interface may comply with CXL standard specifications for physical connectivity, ensuring broad compatibility and ease of integration into existing systems using the CXL protocol. Additionally, or alternatively, a CXL memory system and/or a CXL memory device may be designed to efficiently interface with computing systems (e.g., the host system 105) by leveraging the CXL protocol. For example, a CXL memory system and/or a CXL memory device may be configured to utilize high-speed, low-latency interconnect capabilities of CXL, such as for a purpose of making the CXL memory system and/or the CXL memory device suitable for high-performance computing, data center applications, artificial intelligence (AI) applications, and/or similar applications.

A CXL memory system and/or a CXL memory device may include a CXL memory controller (e.g., memory system controller 115 and/or local controller 125), which may be configured to manage data flow between memory arrays (e.g., volatile memory arrays 135 and/or memory arrays 130) and a CXL interface (e.g., a PCIe/CXL interface, such as host interface 140). In some examples, the CXL memory controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

A CXL memory system and/or a CXL memory device may further include and/or be associated with one or more high-bandwidth memory modules (HBMMs) or similar memory arrays (e.g., volatile memory arrays 135 and/or memory arrays 130). For example, a CXL memory system and/or a CXL memory device may include multiple layers of DRAM (e.g., stacked and/or interconnected through advanced through-silicon via (TSV) technology) in order to maximize storage density and/or enhance data transfer speeds between memory layers. Additionally, or alternatively, a CXL memory system and/or a CXL memory device may include a power management unit, which may be configured to regulate power consumption associated with the CXL memory system and/or the CXL memory device and/or which may be configured to improve energy efficiency for the CXL memory system and/or the CXL memory device. Additionally, or alternatively, a CXL memory system and/or a CXL memory device may include additional components, such as one or more error correction code (ECC) engines, such as for a purpose of detecting and/or correcting data errors to ensure data integrity and/or improve the overall reliability of the CXL memory system and/or the CXL memory device.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from a host system, a first indication of one or more memory address ranges for which accesses are to be monitored and a second indication of a memory unit size to be used by the memory device to monitor accesses to the one or more memory address ranges; determine one or more memory units associated with the one or more memory address ranges; determine, using an access counter for each memory unit, of the one or more memory units, a quantity of accesses to that memory unit during a monitoring period; determine that a corresponding access counter for each memory unit, of a subset of the one or more memory units, satisfies an access threshold; and add an identifier of, and an indication of the corresponding access counter for, each memory unit, of the subset of the one or more memory units, to a data structure based on determining that the corresponding access counter for each memory unit, of the subset of the one or more memory units, satisfies the access threshold.

In some implementations, one or more systems, devices, apparatuses, components, and/or controllers of FIG. 1 may be configured to receive, from a host system, a first indication of one or more memory address ranges for which CXL.mem accesses are to be monitored and a second indication of a memory unit size to be used by the CXL compliant memory device to monitor CXL.mem accesses to the one or more memory address ranges; determine one or more memory units associated with the one or more memory address ranges; determine, using a hotness counter for each memory unit, of the one or more memory units, a quantity of CXL.mem accesses to that memory unit during an epoch; determine that a corresponding hotness counter for each memory unit, of a subset of the one or more memory units, satisfies a hotness threshold; and add an identifier of, and an indication of the corresponding hotness counter for, each memory unit, of the subset of the one or more memory units, to a hotlist based on determining that the corresponding hotness counter for each memory unit, of the subset of the one or more memory units, satisfies the hotness threshold.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

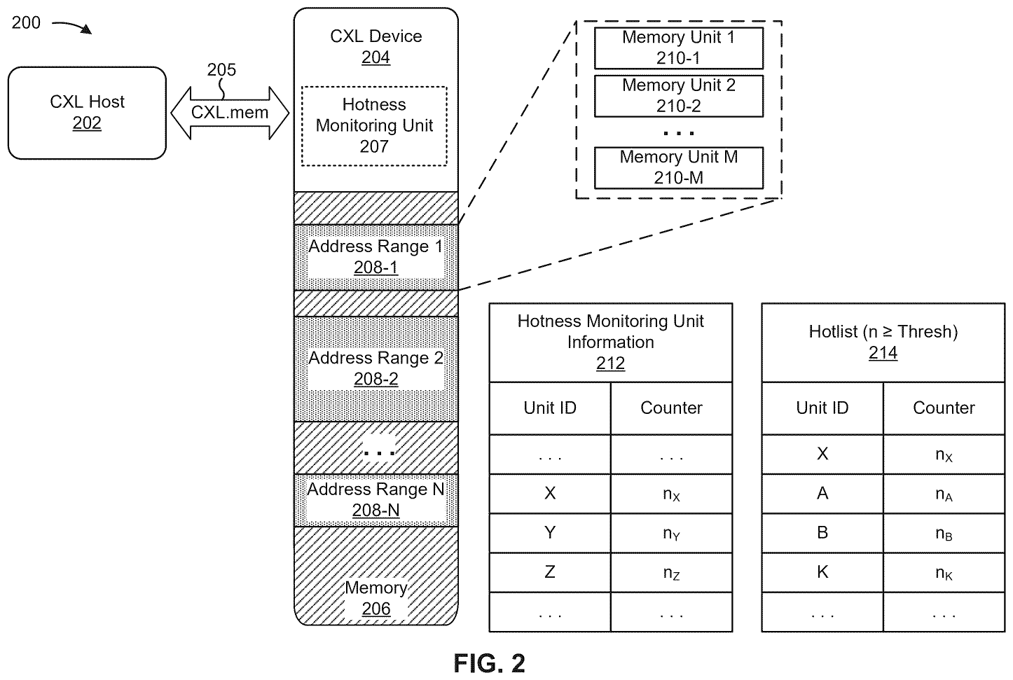

FIG. 2 is a diagram of an example 200 of a system implementing a memory device access monitoring unit interface. The operations described in connection with FIG. 2 may be performed by the memory system 110 and/or one or more components of the memory system 110, such as the memory system controller 115, one or more memory devices 120, and/or one or more local controllers 125.

In some implementations, a host system may communicate with a memory system by transmitting various types of requests and/or similar instructions between the host system and the memory system. More particularly, the example 200 shows an implementation in which a host system communicates with an attached memory system using various requests. In the example 200, the host system is a CXL host 202 that communicates with an attached CXL device 204 using a CXL.mem protocol and/or via CXL.mem requests, as indicated by reference number 205. However, in some other implementations, the operations described in connection with FIG. 2 may be performed by a different type of host (e.g., a host associated with a different type of interface, such as a non-CXL interface), a different type of attached memory system (e.g., a non-CXL device), and/or a different type of protocol (e.g., a non-CXL protocol), without departing from the scope of the disclosure.

In some implementations, the CXL device 204 may be a Type 3 CXL device, such as a memory expansion board, a persistent memory device, and/or a similar Type 3 CXL device used to provide a host system (e.g., the CXL host 202) with low-latency access to local DRAM and/or byte-addressable non-volatile storage, among other examples. Additionally, or alternatively, the CXL device 204 may be associated with a memory 206, which may include multiple DRAM components, among other examples. In some implementations, the CXL device 204 may include a hotness monitoring unit 207 (sometimes referred to herein as an access monitoring unit), which may be a component of the CXL device 204 configured to track accesses to certain portions of the memory 206. Put another way, the hotness monitoring unit 207 may be a component of the CXL device 204 that, once enabled, counts in a specified timeframe (e.g., an epoch) a quantity of memory requests to a configured address range in the CXL device 204 (e.g., a Type 3 CXL device) and identifies hot units, which may be indicated to the CXL host 202 via a hotlist or the like, which is described in more detail below.

In some implementations, the CXL.mem requests indicated by reference number 205 may be associated with read and/or write operations at the CXL device 204. For example, in some implementations, a CXL.mem request may be a memory read (MemRd) request, which may be a request used by the CXL host 202 to read data from a memory 206 (e.g., DRAM memory and/or similar memory) of the CXL device 204. In such examples, a MemRd request may initiate a read operation to fetch data from a specific memory location at the CXL device 204. In some other implementations, a CXL.mem request may be a memory read data (MemRdData) request, which may be a response to a MemRd request. In such examples, the MemRdData request may carry, from the CXL device 204 to the CXL host 202, the actual data read from the memory 206. In some other implementations, a CXL.mem request may be a memory read with trusted execution environment (MemRdTEE) request, which may be similar to a MemRd request but which may be used specifically when accessing memory regions protected by a trusted execution environment (TEE). In some other implementations, a CXL.mem request may be a memory read data with TEE (MemRdDataTEE) request, which may be a response to a MemRdTEE request. In such examples, the MemRdDataTEE request may carry, from the CXL device 204 to the CXL host 202, the actual data read from a memory region protected by TEE. In some other implementations, a CXL.mem request may be a memory speculative read (MemSpecRd) request, which may be a request used for speculative reads (e.g., reads in which the CXL host 202 anticipates requiring certain data before it is actually requested). In such examples, the MemSpecRd request may be used to prefetch data into caches or similar portions of memory, such as for a purpose of reducing latency when the data is later needed by the CXL host 202. In some other implementations, a CXL.mem request may be a memory speculative read with TEE (MemSpecRdTEE) request, which may be similar to a MemSpecRd request but which may be used specifically when accessing memory regions protected by a TEE.

In some other implementations, a CXL.mem request may be a memory write (MemWr) request, which may be a request used by the CXL host 202 to write data to the memory 206 of the CXL device 204. In such examples, a MemWr request may initiate a write operation, such as by providing the data to be written and a destination address for the data. In some other implementations, a CXL.mem request may be a memory write with partial (MemWrPtl) request, which may be a request used by the CXL host 202 when only a portion of the data is being modified in a memory location. In such examples, a MemWrPtl request may specify the data to be written and a byte mask indicating which bytes in the memory location should be updated. In some other implementations, a CXL.mem request may be a memory write with TEE (MemWrTEE) request, which may be similar to a MemWr request but which may be used specifically when writing to memory regions protected by a TEE. In some other implementations, a CXL.mem request may be a memory write with partial and TEE (MemWrPtlTEE) request, which may be similar to a MemWrPtl request but which may be used specifically when writing to memory regions protected by a TEE.

In some implementations, the CXL host 202 may be capable of configuring the CXL device 204 (more particularly, the hotness monitoring unit 207 of the CXL device 204) to track accesses (e.g., certain CXL.mem requests) to portions of the memory 206. In such implementations, the CXL host 202 (e.g., software running on the CXL host 202) may be able to determine a hotness of certain regions in a CXL-attached device (e.g., the CXL device 204) based on access patterns or the like. In that regard, based on configuration information received from the CXL host 202 and/or similar information, the CXL device 204 (more particularly, the hotness monitoring unit 207 of the CXL device 204) may count specified CXL.mem requests associated with portions of the memory 206, and/or the CXL device 204 may output a list or similar data structure indicating hot portions of the memory 206 and the related access counter values (which may or may not be ordered, such as in a descending order of access counter values). In some implementations, the CXL device 204 may count accesses within a configured monitoring period (e.g., epoch) and/or the CXL device 204 may count accesses associated with multiple (e.g., up to 64 in some examples) address ranges specified by the CXL host 202.

More particularly, as shown in example 200, the CXL host 202 may indicate one or more address ranges 208 of the memory 206 to be monitored by the hotness monitoring unit 207, such as a first address range 208-1 through an N-th address range 208-N. In some implementations, each address range 208 may be associated with a contiguous set of device physical addresses (DPAs), with each DPA corresponding to a smallest portion of the memory 206 that is accessible by the CXL device 204. Moreover, in some implementations the hotness monitoring unit 207 may be capable of counting accesses to the memory 206 (e.g., during a specified timeframe and/or epoch) at a memory unit 210 granularity. The memory unit 210 may be a minimum memory size (e.g., 4 kilobytes (kB), 2 megabytes (MB), 1 gigabyte (GB), or 2 GB, among other examples) associated with a given hotness counter (sometimes referred to herein as an access counter), such that, using a given hotness counter, the hotness monitoring unit 207 may track, during an epoch, accesses for a given memory unit 210.

Accordingly, in some implementations, each address range 208 specified by the CXL host 202 may be associated with one or more memory units 210. For example, as shown in example 200, the first address range 208-1 may be associated with M memory units 210, shown in FIG. 2 as a first memory unit 210-1 through an M-th memory unit 210-M. Moreover, as indicated by using varying heights for the address ranges 208 shown in example 200, sizes of the address ranges 208 may vary (e.g., the first address range 208-1 may be associated with a different quantity of DPAs than a second address range 208-2, and so forth). In that regard, the other address ranges 208 (e.g., the second address range 208-2 through the N-th address range 208-N) may be associated with less than M memory units 210, M memory units 210, or more than M memory units 210. In some implementations, the CXL device 204 and/or the hotness monitoring unit 207 may align DPAs to the memory units 210, and/or derive a unit identifier (ID) for each memory unit 210. Put another way, a unit ID may refer to an identifier of a memory unit 210 that is obtained by aligning a request DPA to a size of the memory unit 210. For example, as shown by a hotness monitoring unit information table 212, the CXL device 204 and/or the hotness monitoring unit 207 may derive multiple unit IDs (with only unit IDs X, Y, and Z shown in the hotness monitoring unit information table 212 for ease of discussion, but which, in some other implementations, may include more or fewer unit IDs) corresponding to the memory units 210 associated with the address ranges 208 to be monitored (e.g., the first address range 208-1 through the N-th address range 208-N in example 200).

In some implementations, as requests (e.g., CXL.mem requests) are received within a specified address range 208 and/or as corresponding accesses are made within a specified address range 208, the hotness monitoring unit 207 may count accesses to memory units 210 within the address range 208 (e.g., using a hotness counter for each memory unit 210). More particularly, as indicated by the hotness monitoring unit information table 212, the hotness monitoring unit 207 may maintain a hotness counter for each memory unit 210 within the specified address ranges 208 (shown as n_{unit ID} in the example 200, such as n_{X} corresponding the memory unit 210 associated with unit ID X, n_{Y} corresponding the memory unit 210 associated with unit ID Y, n_{Z} corresponding the memory unit 210 associated with unit ID Z, and so forth). Accordingly, as the CXL device 204 receives requests from the CXL host 202 (e.g., the CXL.mem requests described above in connection with reference number 205, which may indicate that one or more DPAs of the memory 206 are to be read, that one or more DPAs of the memory 206 are to be written to, or the like), the hotness monitoring unit 207 may track accesses to the various memory units 210 within the specified address ranges 208.

In some implementations, the CXL device 204 (e.g., the hotness monitoring unit 207 of the CXL device) may be configured with a hotness threshold (sometimes referred to herein as an access threshold). The hotness threshold may be a value used to determine a hot memory unit 210, such that if a hotness counter of a memory unit 210 satisfies the hotness threshold during an epoch, the memory unit 210 may be identified as a hot unit and thus the corresponding unit ID and/or hotness counter value may be added to a data structure, such as a hotlist 214. Put another way, the hotlist 214 may be a data structure listing hot memory units 210 (e.g., memory units 210 accessed, during an epoch, with a frequency that satisfies the hotness threshold) along with their respective hotness counter values. In this regard, “epoch” may refer to a time interval with a configurable duration, which may be bound to a limit specified by the CXL device 204 (as described in more detail below), during which hotness counters of accessed memory units 210 are updated and/or during which the hotlist 214 of accessed memory units 210 that have satisfied a hotness threshold is populated. For example, as shown in the example 200, hotness counters associated with memory units 210 having unit IDs X, A, B, K, and others may be identified as hot during a specific epoch because a quantity of tracked accesses to the memory units 210 may satisfy a hotness threshold (shown in FIG. 2 as “Thresh”). Accordingly, the unit IDs for the hot memory units (e.g., memory units 210 associated with at least unit IDs X, A, B, and K) may be added to the hotlist along with the respective hotness counter values (e.g., at least n_{X}, n_{A}, n_{B}, and n_{K}).

In some implementations, the CXL device 204 (e.g., the hotness monitoring unit 207 of the CXL device 204) may be configured to save an instance of the hotlist 214 (sometimes referred to herein as a snapshot of the hotlist 214) for a specific epoch, at the end of the specific epoch. For example, the CXL device 204 may save a snapshot in a register used to store one or more snapshots. In this way, the CXL host 202 may be capable of retrieving one or more saved snapshots, such as by accessing a register, in order to obtain a list of hot units and related hotness counters for a given epoch, which is described in more detail below in connection with Tables 5 and 6. Additionally, or alternatively, the CXL host 202 may be capable of configuring the CXL device 204 to reduce the hotness counters (sometimes referred to herein as aging the hotness counters) at an end of an epoch and/or when signaled to do so by the CXL host 202. For example, the CXL host 202 may configure the CXL device 204 to reset the hotness counters to zero at the end of the epoch. Alternatively, the CXL host 202 may configure the CXL device 204 to reduce the hotness counters according to a configurable reduction factor, such as by halving the values of the hotness counters at the end of the epoch, reducing the values of the hotness counters by three-fourths at the end of the epoch, or by reducing the values of the hotness counters by another configurable reduction factor at the end of the epoch. For example, in implementations in which the CXL device 204 is configured to reset the hotness counters at the end of the epoch, the hotness counters shown in connection with the hotness monitoring unit information table 212 may all be set to zero at the end of an epoch. Similarly, in implementations in which the CXL device 204 is configured to halve the hotness counters at the end of the epoch, the hotness counters may be reduced to n_{X}/2, n_{Y}/2, and n_{Z}/2 at the end of the epoch. Moreover, in implementations in which the CXL device 204 is configured to decrease the hotness counters by three-fourths at the end of the epoch, the hotness counters may be reduced to n_{X}/4, n_{Y}/4, and n_{Z}/4 at the end of the epoch.

In some implementations, one or more registers (e.g., small amounts of high-speed storage within the CXL device 204 used for temporary data storage and/or for facilitating communication between the CXL device 204 and other devices, such as the CXL host 202) may be used to indicate hotness monitoring capabilities of the CXL device 204 (more particularly, capabilities of the hotness monitoring unit 207 of the CXL device 204), to indicate configuration information associated with the hotness monitoring unit 207, and/or to transfer data associated with the hotness monitoring unit 207 (e.g., one or more snapshots of the hotlist 214, among other examples). In some implementations, one or more registers used for conveying capability information, configuration information, and/or data may be referred to as access monitoring unit registers, hotness monitoring unit registers, and/or CXL hotness monitoring unit (CHMU) registers, among other examples. For ease of description, the description provided below refers to such registers simply as CHMU registers, but, in some other implementations, similar registers may be utilized for other types of devices (e.g., non-CXL devices) without departing from the scope of the disclosure.

In some implementations, whether a specific device (e.g., the CXL device 204) includes a hotness monitoring unit 207, and/or is otherwise associated with CHMU registers, may be indicated by setting one or more bits in a register locator designated vendor specific extended capability (DVSEC) structure, which may be a structure used to provide information about locations of registers within the device. In such examples, the register locator DVSEC structure may include bits indicating whether the device includes component registers, base address ranges (BAR) virtualization access control list (ACL) registers, CXL performance monitoring unit (CPMU) registers, and/or CHMU registers, among other examples. For example, in some implementations an eight-bit string may be set to 05 hexadecimal, denoted herein as “05h” (e.g., 0000101), to indicate that the CXL device 204 includes CHMU registers and/or that hotness monitoring unit interface features are supported by the CXL device 204.

In some implementations, the CHMU registers may include bits used to indicate capability information associated with the hotness monitoring unit 207, configuration information associated with the hotness monitoring unit 207, and/or to output data (e.g., hotlists and/or snapshots) associated with the hotness monitoring unit 207. For example, Table 1 below shows an example layout of the CHMU registers.

TABLE 1
CHMU Registers Layout

| Byte Offset | Length In Bytes | Register Name |
|---|---|---|
| 00h | 16 | CHMU Capability |
| 10h | 128 | CHMU Configuration |
| 90h | 18 | CHMU Range Configuration 0 |
| A2h | 18 | CHMU Range Configuration 1 |
| . . . | . . . | . . . |
| 4FEh | 18 | CHMU Range Configuration 63 |
| 510h | Variable | CHMU Data |

As shown in Table 1, in some implementations CHMU capability information may be indicated at a byte offset of 00h in the CHMU registers and/or may be 16 bytes in length. Additionally, or alternatively, CHMU configuration information may be indicated at a byte offset of 10h in the CHMU registers and/or may be 128 bytes in length. In some implementations, the CHMU registers may include an indication of one or more address ranges (e.g., address ranges 208) to be monitored by the hotness monitoring unit 207. For example, in the example CHMU registers shown in Table 1, the CHMU registers may include an indication of up to 64 address ranges, indexed as 0 through 63 in Table 1, with each address range configuration (shown as CHMU range configuration 0 through CHMU range configuration 63) having a byte length of 18. In that regard, a first CHMU range configuration may be indicated at a byte offset of 90h in the CHMU registers and/or may be 18 bytes in length, a second CHMU range configuration may be indicated at a byte offset of A2h in the CHMU registers and/or may be 18 bytes in length, and so forth, such that a 64^{th} CHMU range configuration may be indicated at a byte offset of 4FEh in the CHMU register and/or may be 18 bytes in length. Additionally, or alternatively, CHMU data information may be indicated at a byte offset of 510h in the CHMU registers and/or may be associated with a variable quantity of bits.

Table 2, below, shows example CHMU capability information that may be indicated by the CHMU registers. More particularly, Table 2 shows example information that may be indicated at a byte offset of 00h in the CHMU registers and/or that may be indicated using 16 bytes in the CHMU registers. In some implementations, the CHMU capability information may be associated with a set of registers indicating the CXL device 204 capabilities, such as version information, a maximum address space that can be tracked, types of memory-to-storage (M2S) requests that may be tracked, a maximum and/or a minimum epoch length, a maximum hotlist size, certain capability flags, supported hotness thresholds, a maximum counter size supported, supported memory unit sizes, supported aging factors, and/or a maximum quantity of savable snapshots supported, among other information.

TABLE 2
CHMU Capability Information

| | Attrib- | |
|---|---|---|
| Bit | utes | Description |
| 3:0 | HwInit | Version |
| 7:4 | RsvdP | Reserved |
| 23:8 | HwInit | Address Space: maximum contiguous |
| | | address space that can be tracked |
| | | • Bit[3:0] Unit |
| | | ○ 0 h = MB |
| | | ○ 1 h = GB |
| | | ○ other values reserved |
| | | • Bit[15:4] Value |
| | | Value FFFFh means that the hotness tracker |
| | | can cover the entire device capacity |
| 39:24 | HwInit | Tracked M2S Requests: CXL.mem requests |
| | | that can be tracked by the device |
| | | • Bit[0] MemRd |
| | | • Bit[1] MemRdData |
| | | • Bit[2] MemRdTEE |
| | | • Bit[3] MemRdDataTEE |
| | | • Bit[4] MemSpecRd |
| | | • Bit[5] MemSpecRdTEE |
| | | • Bit[6] MemWr |
| | | • Bit[7] MemWrPtl |
| | | • Bit[8] MemWrTEE |
| | | • Bit[9] MemWrPtlTEE |
| | | • Bit[15:10] reserved |
| 55:40 | HwInit | Max Epoch Length: Maximum counting interval length |
| | | that guarantees a high level of fidelity to the output |
| | | • Bits[3:0] These bits specify the time scale |
| | | ○ 1 h = 100 μs |
| | | ○ 2 h = 1 ms |
| | | ○ 3 h = 10 ms |
| | | ○ 4 h = 100 ms |
| | | ○ 5 h = 1 s |
| | | ▪ All other encodings are reserved |
| | | • Bits[15:4] These bits specify the maximum |
| | | operation latency with the time scale indicated in |
| | | bits [3:0] |
| 71:56 | HwInit | Min Epoch Length: Minimum counting interval length |
| | | that guarantees a high level of fidelity to the output |
| | | • Bits[3:0] These bits specify the time scale |
| | | ○ 1 h = 100 μs |
| | | ○ 2 h = 1 ms |
| | | ○ 3 h = 10 ms |
| | | ○ 4 h = 100 ms |
| | | ○ 5 h = 1 s |
| | | ▪ All other encodings are reserved |
| | | • Bits[15:4] These bits specify the minimum |
| | | operation latency with the time scale indicated in |
| | | bits [3:0] |
| 87:72 | HwInit | Max Hotlist Size: Maximum depth of the hotlist |
| | | identified by the device at an end of an epoch |
| 95:88 | HwInit | Capability Flags: Features supported for hotness tracking |
| | | • Bit[0] Ordered hotlist: if set, the hotlist can be |
| | | ordered by descending value |
| | | • Bit[1] Variable counter sizes: if set, more than one |
| | | counter size is supported |
| | | • Bit[2] Aging: if set, counters aging is supported |
| | | • Bit[3] Snapshot saving: if set, the device can save a |
| | | snapshot of the hotlist |
| | | • Bit[4] Down-sampling: if set, the device can reduce |
| | | the requests sampling rate |
| | | • Bit[7:5] reserved |
| 103:96 | HwInit | Hotlist Eviction Policy: Policies adopted by the |
| | | device to evict hot blocks if the hotlist is full |
| | | • Bit[0] LRU |
| | | • Bit[1] LFU |
| | | • Bit[2] Random |
| | | • Bit[3] Vendor Specific |
| | | • Bit[7:4] reserved |
| 111:104 | HwInit | Max Supported Hotness Threshold: Hotness threshold |
| | | maximum values configurable by the host |
| | | (expressed as a power of 2) |
| | | • 00 h: Hotness threshold = 1 |
| | | • 01 h: Hotness threshold = 2 |
| | | • 02 h: Hotness threshold = 4 |
| | | • 03 h: Hotness threshold = 8 |
| | | • . . . |
| 119:112 | HwInit | Max Counter Size Supported: Maximum counter size |
| | | supported by the device to track frequency (field |
| | | is valid if Bit[89] is set; maximum value = 32) |
| 127:120 | HwInit | Supported Unit Sizes: Supported counting granularities |
| | | • Bit[0] 4 kB |
| | | • Bit[1] 2 MB |
| | | • Bit[2] 1 GB |
| | | • Bit[3] 2 GB |
| | | • Bit[7:4] reserved |
| 135:128 | HwInit | Aging Factor: Value of counters decaying when aging is |
| | | executed by the device |
| | | • Bit[0] counters are reset |
| | | • Bit[1] counters are halved |
| | | • Bit[2] counters are reduced by ¾ |
| | | • Bit[7:3] reserved |
| 151:136 | HwInit | Max Number of Saved Hotlist Snapshots: Maximum |
| | | number of hotlist snapshots that |
| | | can be saved by the device. |
| | | This field is valid if Bit[91] is set. |
| 255:137 | RsvdP | Reserved |

More particularly, in some implementations, bits 3:0 of the CHMU capability information may be hardware initialized (HwInit) bits (e.g., register bits that may be initialized by firmware and/or hardware mechanisms and/or that may be read-only bits by the CXL host 202 after initialization) that may be used to indicate a version of CXL hotness monitoring supported by the CXL device 204. Additionally, or alternatively, bits 7:4 may be reserved and preserved (RsvdP) bits (e.g., register bits reserved for future implementations). Moreover, bits 23:8 may be HwInit bits used to indicate a maximum contiguous address space (e.g., a maximum size of an address space 208) that can be tracked by the CXL device 204. For example, of the sixteen bits used to indicate the maximum contiguous address space, the first four bits (e.g., bits 3:0) may be used to indicate a unit of the indicated maximum contiguous address space. For example, when the bits are set to 0h, the unit may be MB, and/or when the bits are set to 1h, the unit may be GB (with all other values and/or encodings reserved), among other examples. The remaining twelve bits (e.g., bits 15:4) may be used to indicate the value of the maximum contiguous address space size. In some implementations, a certain encoding of the sixteen bits used to indicate the maximum contiguous address space size may indicate that the hotness monitoring unit 207 (sometimes referred to in the tables provided herein as a hotness tracker) has a capability of tracking the entire CXL device 204 capacity (e.g., an entire capacity of memory 206). For example, setting all bits to 1 (e.g., setting bits 23:8 to a value of FFFFh) may be used to indicate that the hotness monitoring unit 207 has a capability of monitoring the entire capacity of the CXL device 204.

Additionally, or alternatively, bits 39:24 may be HwInit bits used to indicate types of CXL.mem requests that can be tracked by the hotness monitoring unit 207. For example, setting bit 0 (e.g., using bit 0 to indicate a value of 1 rather than 0) may be used to indicate that the hotness monitoring unit 207 is capable of tracking MemRd requests, setting bit 1 may be used to indicate that the hotness monitoring unit 207 is capable of tracking MemRdData requests, setting bit 2 may be used to indicate that the hotness monitoring unit 207 is capable of tracking MemRdTEE requests, setting bit 3 may be used to indicate that the hotness monitoring unit 207 is capable of tracking MemRdDataTEE requests, setting bit 4 may be used to indicate that the hotness monitoring unit 207 is capable of tracking MemSpecRd requests, setting bit 5 may be used to indicate that the hotness monitoring unit 207 is capable of tracking MemSpecRdTEE requests, setting bit 6 may be used to indicate that the hotness monitoring unit 207 is capable of tracking MemWr requests, setting bit 7 may be used to indicate that the hotness monitoring unit 207 is capable of tracking MemWrPtl requests, setting bit 8 may be used to indicate that the hotness monitoring unit 207 is capable of tracking MemWrTEE requests, and/or setting bit 9 may be used to indicate that the hotness monitoring unit 207 is capable of tracking MemWrPtlTEE requests (with bits 15:10 being reserved), among other examples.

Moreover, bits 55:40 may be HwInit bits used to indicate a maximum epoch length that is supported by the hotness monitoring unit 207 (e.g., a maximum counting interval length that still guarantees a certain level of fidelity to the output). In such examples, the first four bits (e.g., bits 3:0) may be used to indicate a time scale associated with the maximum epoch length. For example, when the bits are set to 1h, the time scale may be 100 microseconds (μs); when the bits are set to 2h, the time scale may be 1 millisecond (ms); when the bits are set to 3h, the time scale may be 10 ms; when the bits are set to 4h, the time scale may be 100 ms; and/or when the bits are set to 5h, the time scale may be 1 second (s) (with all other encodings being reserved), among other examples. The remaining twelve bits (e.g., bits 15:4) may specify the maximum operation latency (e.g., the maximum epoch length) with the time scale indicated by the first four bits (e.g., bits 3:0). Similarly, bits 71:56 may be HwInit bits used to indicate a minimum epoch length that is supported by the hotness monitoring unit 207 (e.g., a minimum counting interval length that still guarantees a certain level of fidelity to the output). In such examples, the first four bits (e.g., bits 3:0) may be used to indicate a time scale associated with the minimum epoch length, in a similar manner as described above in connection with the maximum epoch length field. The remaining twelve bits (e.g., bits 15:4) may specify the minimum operation latency (e.g., the minimum epoch length) with the time scale indicated by the first four bits (e.g., bits 3:0).

Additionally, or alternatively, bits 87:72 may be HwInit bits used to indicate a maximum hotlist size (e.g., a maximum quantity of unit IDs that may be included in the hotlist 214, sometimes referred to herein as a maximum depth of the hotlist 214). Moreover, bits 95:88 may be HwInit bits used as capability flags that indicate certain features that are supported for hotness tracking by the hotness monitoring unit 207. For example, of the eight bits, setting the first bit (e.g., bit 0) to 1 may indicate that the hotness tracking unit 207 is capable of ordering the hotlist, such as by organizing the unit IDs and corresponding hotness counters by descending value of the hotness counters (e.g., listing the hottest unit ID first, followed by the second hottest unit ID, and so forth). Additionally, or alternatively, setting the second bit (e.g., bit 1) to 1 may indicate that the hotness tracking unit 207 is capable of supporting variable hotness sizes (e.g., if set, the hotness monitoring unit 207 may be capable of supporting more than one hotness counter size). Moreover, setting the third bit (e.g., bit 2) to 1 may indicate that the hotness tracking unit 207 is capable of aging the hotness counters at an end of an epoch (e.g., capable of reducing the hotness counters according to a configured reduction factor). Furthermore, setting the fourth bit (e.g., bit 3) to 1 may indicate that the hotness tracking unit 207 is capable of saving one or more snapshots of the hotlist 214. Additionally, or alternatively, setting the fifth bit (e.g., bit 4) to 1 may indicate that the hotness tracking unit 207 is capable of down-sampling (e.g., the hotness monitoring unit 207 is capable of reducing a sampling rate of the requests, such as by a configured down-sampling rate, or the like). In some implementations, the remaining three bits (e.g., bits 7:5) may be reserved.

Additionally, or alternatively, bits 103:96 may be HwInit bits used to indicate a hotlist eviction policy used by the hotness tracking unit 207 to evict hot units from the hotlist 214 when the hotlist 214 is full (e.g., a policy used to replace a certain unit ID/hotness counter value combination included in the hotlist with another unit ID/hotness counter value combination when the hotlist reaches a maximum quantity of unit ID/hotness counter combinations). For example, of the eight bits used to indicate the hotlist eviction policy, setting a first bit (e.g., bit 0) to 1 may indicate that the hotness monitoring unit 207 evicts entries from the hotlist using a least recently used (LRU) policy (e.g., a policy in which a unit ID that was last accessed a longest time ago is evicted), setting a second bit (e.g., bit 1) to 1 may indicate that the hotness monitoring unit 207 evicts entries from the hotlist using a least frequently used (LFU) policy (e.g., a policy in which a unit ID associated with a smallest hotness counter quantity is evicted), setting a third bit (e.g., bit 2) to 1 may indicate that the hotness monitoring unit 207 evicts entries from the hotlist using a random policy (e.g., a policy in which a unit ID is selected at random for eviction), and/or setting a fourth bit (e.g., bit 3) to 1 may indicate that the hotness monitoring unit 207 evicts entries from the hotlist using a vendor-specific policy (e.g., a first-in-first-out (FIFO) policy, a quasi-random policy, or another vendor-specific policy), among other examples. In some implementations, the final four bits (e.g., bits 7:4) may be reserved bits.

Moreover, bits 111:104 may be HwInit bits used to indicate a maximum supported hotness threshold size associated with the hotness monitoring unit 207. For example, in some implementations, the value indicated by bits 111:104 may indicate a power of two used to identify the maximum supported hotness threshold. Accordingly, when the bits indicate 00h, the maximum supported hotness threshold may be equal to 2⁰=1; when the bits indicate 01h, the maximum supported hotness threshold may be equal to 2¹=2; when the bits indicate 02h, the maximum supported hotness threshold may be equal to 2²=4; when the bits indicate 03h, the maximum supported hotness threshold may be equal to 2³=8; and so forth. Additionally, or alternatively, bits 119:112 may be HwInit bits used to indicate a maximum supported hotness counter size. In some implementations, the field indicated by bits 119:112 may only be valid if bit 89 of the CHMU capability information is set, which is the bit described above in connection with the capability flags that indicates whether the hotness tracking unit 207 supports variable counter sizes. Moreover, in some implementations, a maximum value that may be indicated by bits 119:112 (e.g., a maximum value that may be indicated as the maximum hotness counter size) may be 32.

Additionally, or alternatively, bits 127:120 may be HwInit bits used to indicate supported memory unit 210 sizes (e.g., supported counting granularities) supported by the hotness monitoring unit 207. For example, of the eight bits, setting a first bit (e.g., bit 0) to 1 may indicate that the hotness monitoring unit 207 supports tracking memory units (e.g., memory units 210) having a size of 4 kB, setting a second bit (e.g., bit 1) to 1 may indicate that the hotness monitoring unit 207 supports tracking memory units having a size of 2 MB, setting a third bit (e.g., bit 2) to 1 may indicate that the hotness monitoring unit 207 supports tracking memory units having a size of 1 GB, and/or setting a fourth bit (e.g., bit 3) to 1 may indicate that the hotness monitoring unit 207 supports tracking memory units having a size of 2 GB (with bits 7:4 being reserved), among other examples. Moreover, bits 135:128 may be HwInit bits used to indicate supported aging factors by the hotness monitoring unit 207 (e.g., reduction factors that may be used to reduce the hotness counters at an end of an epoch). For example, of the eight bits, setting a first bit (e.g., bit 0) to 1 may indicate that the hotness counters may be reset to zero at the end of the epoch, setting a second bit (e.g., bit 1) to 1 may indicate that the hotness counters may be halved at the end of the epoch, and/or setting a third bit (e.g., bit 2) to 1 may indicate that the hotness counters may be reduced by % at the end of the epoch (with bits 7:3 being reserved), among other examples.

Additionally, or alternatively, bits 151:136 may be HwInit bits used to indicate a maximum quantity of instances of the hotlist 214 (e.g., a maximum quantity of snapshots) that may be saved by the hotness monitoring unit 207. In some implementations, the field indicated by bits 151:136 may only be valid if bit 91 of the CHMU capability information is set, which is the bit described above in connection with the capability flags that indicates whether the hotness tracking unit 207 supports snapshot saving. Moreover, in some implementations, the remaining bits associated with the CHMU capability information (e.g., bits 255:137) may be reserved (e.g., bits 255:137 may be RsvdP bits).

Table 3, below, shows example CHMU configuration information that may be indicated by the CHMU registers. More particularly, Table 3 shows example information that may be indicated at a byte offset of 10h in the CHMU registers and/or that may be indicated using 128 bytes in the CHMU registers. In some implementations, the CHMU configuration information may be associated with a set of registers indicating configuration parameters for the hotness monitoring unit 207, such as whether the hotness monitoring unit 207 is to be enabled, types of M2S requests to be tracked, a configured hotness threshold, a configured hotlist size, certain configuration flags, a configured hotness counter size, a configured memory unit size, a configured epoch length, a configured aging type, certain control information, and/or configured address ranges to be tracked.

TABLE 3
CHMU Configuration Information

| | Attrib- | |
|---|---|---|
| Bit | utes | Description |
| 0 | RW | Enable |
| | | • 0 = Hotness monitoring unit disabled |
| | | (reset default of this bit is 0) |
| | | • 1 = Hotness monitoring unit enabled |
| 7:1 | RsvdP | Reserved |
| 23:8 | RW | M2S Request to Track: CXL.mem requests |
| | | that are to be tracked by the device |
| | | • Bit[0] MemRd |
| | | • Bit[1] MemRdData |
| | | • Bit[2] MemRdTEE |
| | | • Bit[3] MemRdDataTEE |
| | | • Bit[4] MemSpecRd |
| | | • Bit[5] MemSpecRdTEE |
| | | • Bit[6] MemWr |
| | | • Bit[7] MemWrPtl |
| | | • Bit[8] MemWrTEE |
| | | • Bit[9] MemWrPtlTEE |
| | | • Bit[15:10] reserved |
| 31:24 | RW | Hotness Threshold: Hotness threshold value |
| | | configured by the host (expressed as a power of 2) |
| | | • 00 h: Hotness threshold = 1 |
| | | • 01 h: Hotness threshold = 2 |
| | | • 02 h: Hotness threshold = 4 |
| | | • 03 h: Hotness threshold = 8 |
| | | • . . . |
| 47:32 | RW | Hotlist Size: Depth of the hotlist configured by the host |
| 55:48 | RW | Flags: Features supported for hotness tracking |
| | | • Bit[0] Ordered hotlist: if set, the hotlist shall be |
| | | ordered by descending value |
| | | • Bit[1] Snapshot saving: if set, the device shall save |
| | | a snapshot of the hotlist |
| | | • Bit[2] Aging enablement: if set, aging is performed |
| | | on the counters following the aging mode |
| | | defined in |
| | | Bit[3]. If not set, the counters will be reset at the |
| | | end of each epoch |
| | | • Bit[3] Aging mode: if set to one, the aging is |
| | | controlled by the host. If set to zero, the counters |
| | | are aged at the end of an epoch |
| | | • Bit[4] Down-sampling: if set, the device shall |
| | | reduce the requests sampling rate by a configurable |
| | | factor |
| | | • Bit[7:5] reserved |
| 63:56 | RW | Counter Size: Counter size configured |
| | | by the host to track access frequency. |
| | | The filed can be configured only if the |
| | | feature is supported by the device. |
| 71:64 | RW | Unit Size: Counting granularity configured by the host |
| | | • Bit[0] 4 kB |
| | | • Bit[1] 2 MB |
| | | • Bit[2] 1 GB |
| | | • Bit[3] 2 GB |
| | | • Bit[7:4] reserved |
| 79:72 | RW | Epoch Length: Counting interval configured by the host |
| | | • Bits[3:0] These bits specify the time scale |
| | | ○ 1 h = 100 μs |
| | | ○ 2 h = 1 ms |
| | | ○ 3 h = 10 ms |
| | | ○ 4 h = 100 ms |
| | | ○ 5 h = 1 s |
| | | ▪ All other encodings are reserved |
| | | • Bits[15:4] These bits specify the maximum |
| | | operation latency with the time scale indicated in |
| | | bits [3:0] |
| 87:80 | RW | Aging Type: Value of counters decaying when aging is |
| | | executed by the device |
| | | • Bit[0] counters are reset |
| | | • Bit[1] counters are halved |
| | | • Bit[2] counters are reduced by 3/4 |
| | | • Bit[7:3] reserved |
| 103:88 | RW | Control |
| | | • Bit[0] Reset |
| | | • Bit[1] Execute aging of the counters |
| | | • Bit[16:2] reserved |
| 127:104 | RsvdP | Reserved |

More particularly, in some implementations, bit 0 of the CHMU configuration information may be a read-write (RW) bit (e.g., a register bit that is read-write and/or that may be set and/or cleared by software to a desired state) that may be used to indicate whether the CXL device 204 is to enable the hotness monitoring unit 207. For example, when the bit is set to 0 (which may be a default state), the hotness monitoring unit 207 may be disabled, and when the bit is set to 1, the hotness monitoring unit 207 may be enabled. Additionally, or alternatively, bits 7:1 may be RsvdP bits. Moreover, bits 23:8 may be RW bits used to indicate types of CXL.mem requests that are to be tracked by the hotness monitoring unit 207. For example, setting a first bit (e.g., bit 0) to 1 may be used to indicate that the hotness monitoring unit 207 is to track MemRd requests, setting a second bit (e.g., bit 1) to 1 may be used to indicate that the hotness monitoring unit 207 is to track MemRdData requests, setting a third bit (e.g., bit 2) to 1 may be used to indicate that the hotness monitoring unit 207 is to track MemRdTEE requests, setting a fourth bit (e.g., bit 3) to 1 may be used to indicate that the hotness monitoring unit 207 is to track MemRdDataTEE requests, setting a fifth bit (e.g., bit 4) to 1 may be used to indicate that the hotness monitoring unit 207 is to track MemSpecRd requests, setting a sixth bit (e.g., bit 5) to 1 may be used to indicate that the hotness monitoring unit 207 is to track MemSpecRdTEE requests, setting a seventh bit (e.g., bit 6) to 1 may be used to indicate that the hotness monitoring unit 207 is to track MemWr requests, setting an eighth bit (e.g., bit 7) to 1 may be used to indicate that the hotness monitoring unit 207 is to track MemWrPtl requests, setting a ninth bit (e.g., bit 8) to 1 may be used to indicate that the hotness monitoring unit 207 is to track MemWrTEE requests, and/or setting a tenth bit (e.g., bit 9) to 1 may be used to indicate that the hotness monitoring unit 207 is to track MemWrPtlTEE requests (with bits 15:10 being reserved), among other examples.

Moreover, bits 31:24 may be RW bits used to indicate a hotness threshold size to be used by the hotness monitoring unit 207. In some implementations, the value indicated by bits 31:24 may indicate a power of two used to identify the hotness threshold size to be used by the hotness monitoring unit 207. Accordingly, when the bits indicate 00h, the hotness monitoring unit 207 may be configured to use a hotness threshold equal to 2⁰=1; when the bits indicate 01h, the hotness monitoring unit 207 may be configured to use a hotness threshold equal to 2¹=2; when the bits indicate 02h, the hotness monitoring unit 207 may be configured to use a hotness threshold equal to 2²=4; when the bits indicate 03h, the hotness monitoring unit 207 may be configured to use a hotness threshold equal to 2³=8; and so forth.

Additionally, or alternatively, bits 47:32 may be RW bits used to indicate a hotlist size to be used by the hotness monitoring unit 207 (e.g., bits 47:32 may indicate a depth of the hotlist that is returned by the hotness monitoring unit 207). Moreover, bits 55:48 may be RW bits used as configuration flags to indicate certain features to be implemented during hotness tracking by the hotness monitoring unit 207. For example, of the eight bits, setting the first bit (e.g., bit 0) to 1 may indicate that the hotness tracking unit 207 is to return an ordered hotlist 214 (e.g., the hotness monitoring unit 207 is to organize the unit ID/hotness counter pairs by descending value of the hotness counters). Additionally, or alternatively, setting the second bit (e.g., bit 1) to 1 may indicate that the hotness tracking unit 207 is to save an instance of the hotlist 214 (e.g., a snapshot) at the end of an epoch. Moreover, setting the third bit (e.g., bit 2) to 1 may indicate that the hotness tracking unit 207 is to age the hotness counters at an end of an epoch (e.g., reduce the hotness counters according to a configured reduction factor), such as by aging the hotness counters following an aging mode indicated by the fourth bit (e.g., bit 3). In that regard, setting the fourth bit (e.g., bit 3) to 1 may indicate that aging is controlled by the CXL host 202 (e.g., by setting a control bit, which is described in more detail below in connection with bits 103:88), and/or setting the fourth bit to 0 may indicate that the hotness tracking unit 207 is to age the hotness counters at the end of an epoch. Additionally, or alternatively, setting the fifth bit (e.g., bit 4) to 1 may indicate that the hotness tracking unit 207 is to perform down-sampling, such as by reducing a sampling rate of the CXL.mem requests by a configured down-sampling rate, or the like. In some implementations, the remaining three bits (e.g., bits 7:5) may be reserved.

Additionally, or alternatively, bits 63:56 may be RW bits used to indicate a hotness counter size to be used by the hotness monitoring unit 207. In some implementations, the field indicated by bits 63:56 may only be valid if the hotness monitoring unit 207 supports variable hotness counter sizes (e.g., the field indicated by bits 63:56 may only be valid if bit 89 of the CHMU capability information described above in connection with Table 2 is set to 1). Moreover, bits 71:64 may be RW bits used to indicate a memory unit size (e.g., a counting granularity) to be used by the hotness monitoring unit 207. For example, of the eight bits, setting a first bit (e.g., bit 0) to 1 may indicate that the hotness monitoring unit 207 is to track memory units (e.g., memory units 210) having a size of 4 kB, setting a second bit (e.g., bit 1) to 1 may indicate that the hotness monitoring unit 207 is to track memory units having a size of 2 MB, setting a third bit (e.g., bit 2) to 1 may indicate that the hotness monitoring unit 207 is to track memory units having a size of 1 GB, and/or setting a fourth bit (e.g., bit 3) to 1 may indicate that the hotness monitoring unit 207 is to track memory units having a size of 2 GB (with bits 7:4 being reserved), among other examples.

Additionally, or alternatively, bits 79:72 may be RW bits used to indicate an epoch length that is to be used by the hotness monitoring unit 207. In such examples, the first four bits (e.g., bits 3:0) may be used to indicate a time scale associated with the epoch length. For example, when the bits are set to 1h, the time scale may be 100 μs; when the bits are set to 2h, the time scale may be 1 ms; when the bits are set to 3h, the time scale may be 10 ms; when the bits are set to 4h, the time scale may be 100 ms; and/or when the bits are set to 5h, the time scale may be 1 s (with all other encodings being reserved), among other examples. The remaining twelve bits (e.g., bits 15:4) may specify the maximum operation latency (e.g., the epoch length) with the time scale indicated by the first four bits (e.g., bits 3:0).

Additionally, or alternatively, bits 87:80 may be RW bits used to indicate an aging type to be used by the hotness monitoring unit 207 (e.g., a reduction factor to be used to reduce the hotness counters at an end of an epoch). For example, of the eight bits, setting a first bit (e.g., bit 0) to 1 may indicate that the hotness counters are to be reset to zero at the end of the epoch, setting a second bit (e.g., bit 1) to 1 may indicate that the hotness counters are to be halved at the end of the epoch, and/or setting a third bit (e.g., bit 2) to 1 may indicate that the hotness counters are to be reduced by % at the end of the epoch (with bits 7:3 being reserved), among other examples. Moreover, bits 103:88 may be RW bits used to indicate certain control information associated with the hotness monitoring unit 207. For example, setting the first bit (e.g., bit 0) to 1 may indicate that the hotness monitoring unit 207 and/or a hotness tracking operation is to be reset, and/or setting the second bit (e.g., bit 1) to 1 may indicate that the hotness monitoring unit 207 is to execute aging of the hotness counters (e.g., in examples in which bit 51, described above in connection with the configuration flags indicated by bits 55:48, indicates that aging is controlled by the CXL host 202), with bits 16:2 being reserved. Moreover, in some implementations, the remaining bits associated with the CHMU configuration information (e.g., bits 127:104) may be reserved (e.g., bits 127:104 may be RsvdP bits).

Table 4, below, shows example CHMU range configuration information that may be indicated by the CHMU registers. More particularly, Table 4 shows example information that may be indicated for a specific address range (indicated below generically as a CHMU range configuration N) using one of the byte offsets associated with a CHMU range configuration (e.g., byte offset of 90h for CHMU range configuration 0, byte offset A2h for CHMU range configuration 1, and so forth, through byte offset 4Feh for CHMU range configuration 63) in the CHMU registers and/or that may be indicated using 18 bytes in the CHMU registers. In some implementations, the CHMU range configuration N information may be associated with a set of registers indicating address ranges to be tracked by the hotness monitoring unit 207.

TABLE 4
CHMU Range Configuration N Information

| Bit | Attributes | Description |
|---|---|---|
| 0 | RW | Enable: When this bit is set, the Hotness |
| | | Monitoring Unit is enabled on the address |
| | | range specified by the parameters below |
| 15:1 | RsvdP | Reserved |
| 79:16 | RW | Start Address: Start DPA to track accesses |
| 143:80 | RW | End Address: End DPA to track accesses |

More particularly, in some implementations, bit 0 of the CHMU range configuration N information may be an RW bit that may be used to indicate whether the hotness monitoring unit 207 is enabled on one or more address ranges (e.g., address ranges 208) further specified by the CHMU range configuration N information (e.g., specified by bits 143:16, described in more detail below). For example, as described above in connection with Table 1, in some implementations the CXL host 202 may be capable of specifying up to 64 address ranges for tracking, such as by using 18 bytes in the CHMU registers to specify each range. Accordingly, for each potential range to be specified (e.g., for each set of 18 bytes corresponding to the potential 64 ranges that may be specified), the CXL host 202 may set a first bit (e.g., bit 0) to 1 to indicate that the hotness monitoring unit 207 is enabled on the specified range, and/or the CXL host 202 may set the first bit to 0 to indicate that the hotness monitoring unit 207 is not enabled for the particular range. Additionally, or alternatively, bits 15:1 may be RsvdP bits. Moreover, the remaining bits of the CHMU range configuration N information may be used by the CXL host 202 to specify a contiguous range of memory addresses (e.g., a contiguous range of DPAs) to be tracked by the hotness monitoring unit 207. For example, bits 79:16 may be used to specify a start address of the corresponding range (e.g., a start DPA at which accesses are to be tracked) and/or bits 143:80 may be used to specify an end address of the corresponding range (e.g., an end DPA at which accesses are to be tracked).

Table 5, below, shows example CHMU data information that may be indicated by the CHMU registers. More particularly, Table 5 shows example information that may be indicated at a byte offset of 510h in the CHMU registers and/or that may be indicated using a variable quantity of bytes (e.g., variable according to a quantity of snapshots to be saved) in the CHMU registers. In some implementations, the CHMU data information may be associated with a set of registers indicating instances of the hotlist 214 (e.g., snapshots) with related sequence numbers, such as for a purpose of uniquely identifying the corresponding instance of the hotlist.

TABLE 5
CHMU Data Information

| Bit | Attributes | Description |
|---|---|---|
| 15:0 | R | Number of Snapshots: Number |
| | | of available snapshots. |
| | | If snapshot saving is enabled |
| | | on the device, this value |
| | | corresponds to the number |
| | | of snapshots currently saved |
| | | on the device. If snapshot |
| | | saving is not supported, this |
| | | value is equal to 1. |
| Variable:16 | R | Snapshot 0 |
| . . . | . . . | . . . |
| Variable | R | Snapshot N-1 |

More particularly, in some implementations, bits 15:0 of the CHMU data information may be a read (R) bit (e.g., a bit that can be read by the CXL host 202, but not written to by the CXL host 202) that may be used by the hotness monitoring unit 207 to indicate a quantity of snapshots (e.g., instances of the hotlist) that are saved at the CXL device 204 (e.g., within the CHMU data information of the CHMU registers). More particularly, if snapshot saving is enabled on the device (e.g., if the CXL device 204 indicates that it has a capability to save snapshots via bit 91 of the CHMU capability information and/or if snapshot saving is configured via bit 49 of the CHMU configuration information), these bits may correspond to the quantity of snapshots currently saved on the CXL device 204. In some implementations, if snapshot saving is not supported (e.g., if the CXL device 204 indicates that it does not have a capability to save snapshots via bit 91 of the CHMU capability information and/or if snapshot saving is not configured via bit 49 of the CHMU configuration information), this value may be equal to 1. Additionally, or alternatively, a maximum quantity of snapshots that may be saved on the CXL device 204 may be a device capability specified by the CHMU capability information (e.g., at bits 151:136 of the CHMU capability information, as described above).

In some implementations, the remaining bits of the CHMU data information may be R bits used to indicate the various snapshots saved on the CXL device 204. For example, a first set of variable length bits (e.g., variable because the size of a snapshot may be dependent on the quantity of hot units identified in a given epoch and/or a depth of the hotlist 214 configured by the CXL host 202) may be used to indicate a first of N snapshots saved on the CXL device 204 (indexed as snapshot 0 in Table 5), a second set of variable length bits may be used to indicate a second of N snapshots saved on the CXL device 204, and so forth, through an N-th set of variable length bits that may be used to indicate an N-th snapshot saved on the CXL device 204 (indexed as snapshot N−1 in Table 5).

Table 6, below, shows example snapshot information that may be indicated by the CHMU registers. More particularly, Table 6 shows example information that may be indicated for each snapshot described above in connection with Table 5. In some implementations, the snapshot information indicates a list of unit IDs for which a hotness counter satisfied a hotness threshold during a given epoch and, for each unit ID, a corresponding counter value.

TABLE 6
Snapshot Information

| Bit | Attributes | Description |
|---|---|---|
| 15:0 | R | Sequence Number |
| 31:16 | RsvdP | Reserved |
| 47:32 | R | Number of Hot Units |
| 111:48 | R | Unit ID 0 |
| 143:112 | R | Counter Value 0 |
| 207:144 | R | Unit ID 1 |
| 239:208 | R | Counter Value 1 |
| . . . | . . . | . . . |
| (48 + 96 × N + 63): | R | Unit ID N-1 |
| (48 + 96 × N) | | |
| (48 + 96 × N + 95): | R | Counter Value N-1 |
| (48 + 96 × N + 64) | | |

More particularly, bits 15:0 may be R bits used to identify a sequence number associated with the given snapshot. Put another way, each snapshot may be associated with a unique 16-bit sequence number such that the CXL host 202 may uniquely identify the snapshot and/or an epoch for which the corresponding snapshot applies. Moreover, in some implementations, bits 31:16 may be reserved (e.g., bits 31:16 may be RsvdP bits). In some implementations, bits 47:32 may be R bits used to indicate a quantity of hot units included in the snapshot. In some implementations, a maximum number of hot units may be limited from the hotlist depth advertised by the CXL device 204 through the CHMU capability information described above (e.g., via bits 87:72 of the CHMU capability information). The remaining bits may be used to indicate the N hot units for the given snapshot and the corresponding hotness counter values for the given snapshot. For example, bits 111:48 may be R bits used to indicate a unit ID of a first hot unit (indexed in Table 6 a unit ID 0) and bits 143:112 may be R bits used to indicate a corresponding counter value for the first hot unit (indexed in Table 6 as counter value 0), bits 207:144 may be R bits used to indicate a unit ID of a second hot unit (indexed in Table 6 a unit ID 1), and bits 239:208 may be R bits used to indicate a corresponding counter value for the second hot unit (indexed in Table 6 as counter value 1), and so forth, through bits (48+96×N+63):(48+96×N) that may be R bits used to indicate a unit ID of an N-th hot unit (indexed in Table 6 as unit ID N−1) and bits (48+96×N+95):(48+96×N+64) that may be R bits used to indicate a corresponding counter value for the N-th hot unit (indexed in Table 6 as counter value N−1).

As indicated above, FIG. 2 is provided as an example. Other examples may differ from what is described with regard to FIG. 2.

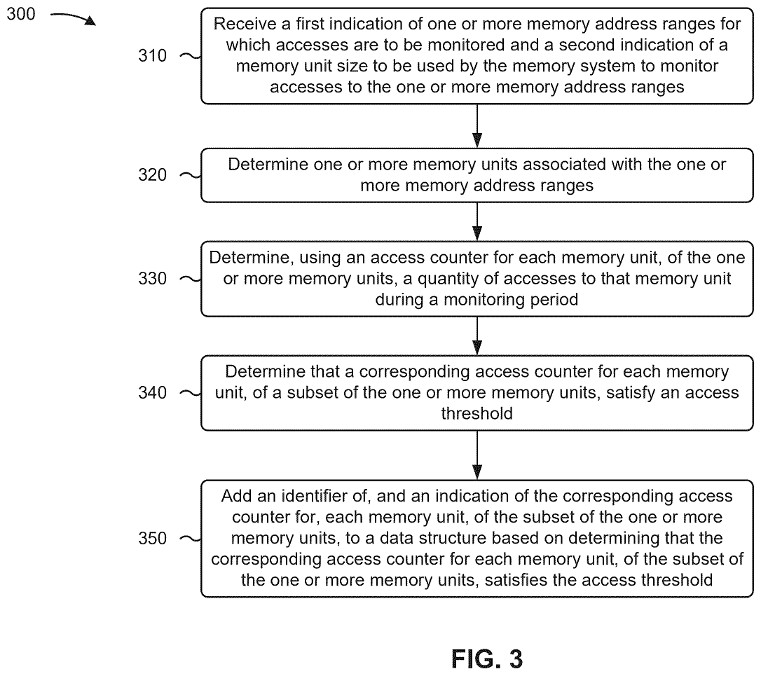

FIG. 3 is a flowchart of an example method 300 associated with a memory device access monitoring unit interface. In some implementations, a memory system (e.g., the memory system 110) may perform or may be configured to perform the method 300. In some implementations, another device or a group of devices separate from or including the memory system (e.g., memory device 120 and/or CXL device 204) may perform or may be configured to perform the method 300. Additionally, or alternatively, one or more components of the memory system (e.g., memory system controller 115, one or more local controllers 125, and/or hotness monitoring unit 207) may perform or may be configured to perform the method 300. Thus, means for performing the method 300 may include the memory system and/or one or more components of the memory system. Additionally, or alternatively, a non-transitory computer-readable medium may store one or more instructions that, when executed by the memory system, cause the memory system to perform the method 300.

As shown in FIG. 3, the method 300 may include receiving a first indication of one or more memory address ranges for which accesses are to be monitored and a second indication of a memory unit size to be used by the memory system to monitor accesses to the one or more memory address ranges (block 310). For example, the CXL device 204 and/or the hotness monitoring unit 207 may receive an indication of multiple address ranges 208, such as via the CHMU range configuration N information of the CHMU registers, described above in connection with Table 4, and/or an indication of a memory unit 210 size (e.g., one of 4 kB, 2 MB, 1 GB, or 2 GB, among other examples), such as via the CHMU configuration information of the CHMU registers, described above in connection with Table 3 (e.g., via bits 71:64 of the CHMU configuration information). As further shown in FIG. 3, the method 300 may include determining one or more memory units associated with the one or more memory address ranges (block 320). For example, the CXL device 204 and/or the hotness monitoring unit 207 may align incoming DPAs to one or more memory units 210, such as according to a configured memory unit size, described above in connection with bits 127:120 of the CHMU capability information of the CHMU registers and/or bits 71:64 of the CHMU configuration information of the CHMU registers. Put another way, the host system (e.g., host system 105) may set up the desired memory unit size to be used by the memory system, such as via the CHMU configuration information of the CHMU registers, described above in connection with Table 3 (e.g., via bits 71:64 of the CHMU configuration information), and the memory system may use the set up memory unit size to determine a quantity of memory units that are encompassed by a given memory address range.

As further shown in FIG. 3, the method 300 may include determining, using an access counter for each memory unit, of the one or more memory units, a quantity of accesses to that memory unit during a monitoring period (block 330). For example, the CXL device 204 and/or the hotness monitoring unit 207 may monitor CXL.mem requests to each memory unit during a configured epoch (e.g., an epoch configured by bits 79:72 of the CHMU configuration information of the CHMU registers), such as by monitoring the specific types of CXL.mem requests indicated by bits 23:8 of the CHMU configuration information of the CHMU registers (described above in connection with Table 3). As further shown in FIG. 3, the method 300 may include determining that a corresponding access counter for each memory unit, of a subset of the one or more memory units, satisfies an access threshold (block 340). For example, the CXL device 204 and/or the hotness monitoring unit 207 may determine that the hotness counters associated with a subset of memory units 210 satisfy a configured hotness threshold, such as a hotness threshold configured by bits 31:24 of the CHMU configuration information of the CHMU registers (described above in connection with Table 3). As further shown in FIG. 3, the method 300 may include adding an identifier of, and an indication of the corresponding access counter for, each memory unit, of the subset of the one or more memory units, to a data structure based on determining that the corresponding access counter for each memory unit, of the subset of the one or more memory units, satisfies the access threshold (block 350). For example, the CXL device 204 and/or the hotness monitoring unit 207 may add a unit ID/hotness counter pair to the hotlist 214 based on determining that each unit ID/hotness counter pair satisfies the configured hotness threshold.

The method 300 may include additional aspects, such as any single aspect or any combination of aspects described below and/or described in connection with one or more other methods or operations described elsewhere herein.

In the first aspect, the memory system is a CXL memory system, and the accesses that are to be monitored are associated with CXL.mem requests. For example, the memory system may be, or else may be associated with, the CXL device 204, and/or the CXL.mem requests may be requests for which the CXL device 204 has a capability of tracking (e.g., as indicated via bits 39:24 of the CHMU capability information of the CHMU registers, described above in connection with Table 2) and/or for which the CXL device 204 is configured to track (e.g., as indicated via bits 23:8 of the CHMU configuration information of the CHMU registers, described above in connection with Table 3).

In a second aspect, alone or in combination with the first aspect, the method 300 includes receiving, by the memory system and from the host system, an indication of the access threshold. For example, the CXL device 204 and/or the hotness monitoring unit 207 may receive, from the CXL host, an indication of the hotness threshold via bits 31:24 of the CHMU configuration information of the CHMU registers, described above in connection with Table 3.

In a third aspect, alone or in combination with one or more of the first and second aspects, the method 300 includes saving, by the memory system, a plurality of instances of the data structure. For example, the CXL device 204 and/or the hotness monitoring unit 207 may save multiple snapshots in the CHMU registers, such as by using the CHMU data information of the CHMU registers, as described above in connection with Table 5, and/or by using the CHMU snapshot information of the CHMU registers, as described above in connection with Table 6.

In a fourth aspect, alone or in combination with one or more of the first through third aspects, the method 300 includes receiving, by the memory system and from the host system, an indication that each access counter is to be reduced after the monitoring period, and reducing, by the memory system, each access counter based on receiving the indication that each access counter is to be reduced. For example, the CXL device 204 and/or the hotness monitoring unit 207 may receive an indication of aging enablement (e.g., via bit 50 of the CHMU configuration information of the CHMU registers, as described above in connection with Table 3), an indication of an aging mode to be used by the CXL device 204 and/or the hotness monitoring unit 207 (e.g., via bit 51 of the CHMU configuration information of the CHMU registers, as described above in connection with Table 3), and/or an indication of an aging type to be used by the CXL device 204 and/or the hotness monitoring unit 207 (e.g., via bits 87:80 of the CHMU configuration information of the CHMU registers, as described above in connection with Table 3), and/or the CXL device 204 and/or the hotness monitoring unit 207 may thus reduce each hotness counter at an end of an epoch based on the configured aging type.

In a fifth aspect, alone or in combination with one or more of the first through fourth aspects, the method 300 includes indicating, by the memory system to the host system and via an access monitoring unit register, capability information indicating one or more parameters associated with monitoring accesses to the one or more memory units. For example, CXL device 204 and/or the hotness monitoring unit 207 may indicate, to the CXL host 202, capability information via the CHMU capability information of the CHMU registers, as described above in connection with Table 2.

In a sixth aspect, alone or in combination with one or more of the first through fifth aspects, the capability information indicates at least one of whether monitoring accesses to the one or more memory units is supported by the memory system, a maximum memory address range size supported by the memory system, one or more types of accesses that can be monitored by the memory system, a maximum monitoring period size supported by the memory system, a minimum monitoring period size supported by the memory system, a maximum data structure size supported by the memory system, a type of data structure sorting supported by the memory system, whether the memory system supports variable access counter sizes, whether the memory system supports reducing access counters at an end of the monitoring period, whether the memory system supports saving one or more instances of the data structure, whether the memory system supports a reduction in a sampling rate associated with the access counters, a data structure eviction policy supported by the memory system, a maximum access threshold supported by the memory system, a maximum access counter size supported by the memory system, one or more memory unit sizes supported by the memory system, one or more access counter reduction factors supported by the memory system, or a maximum number of saved instances of the data structure supported by the memory system. For example, the CXL device 204 and/or the hotness monitoring unit 207 may indicate, to the CXL host 202 via the CHMU registers, any or all of the capability information described above in connection with Table 2.

In a seventh aspect, alone or in combination with one or more of the first through sixth aspects, the method 300 includes receiving, by the memory system from the host system and via an access monitoring unit register, configuration information indicating one or more parameters associated with monitoring accesses to the one or more memory units. For example, CXL device 204 and/or the hotness monitoring unit 207 may receive, from the CXL host 202, configuration information via the CHMU configuration information of the CHMU registers, as described above in connection with Table 3.

In an eighth aspect, alone or in combination with one or more of the first through seventh aspects, the configuration information indicates at least one of whether monitoring accesses to the one or more memory units is to be enabled, one or more types of accesses that are to be monitored by the memory system, a size of the access threshold, a size of the data structure, a type of data structure sorting to be used by the memory system, whether the memory system is to save one or more instances of the data structure, whether the memory system is to reduce access counters at an end of the monitoring period, whether the memory system is to reduce access counters when indicated to do so by the host system, whether the memory system is to reduce a sampling rate associated with access counters, an access counter size to be used by the memory system, a memory unit size to be used by the memory system, a monitoring period size to be used by the memory system, a type of reduction factor to be used to reduce access counters at the end of the monitoring period, control information associated with at least of one resetting a monitoring operation or reducing access counters, or the one or more memory address ranges for which the accesses are to be monitored. For example, the CXL device 204 and/or the hotness monitoring unit 207 may receive, from the CXL host 202 via the CHMU registers, any or all of the configuration information described above in connection with Table 3.

In a ninth aspect, alone or in combination with one or more of the first through eighth aspects, the method 300 includes indicating, by the memory system to the host system and via an access monitoring unit register, at least one of a quantity of a plurality of instances of the data structure that have been saved by the memory system, or an indication of each instance of the data structure, of the plurality of instances of the data structure that have been saved by the memory system. For example, the CXL device 204 and/or the hotness monitoring unit 207 may indicate, to the CXL host 202 via the CHMU data information of the CHMU registers described above in connection with Tables 5 and 6, a quantity of snapshots that have been saved in the CHMU registers and/or each saved snapshot.

Although FIG. 3 shows example blocks of a method 300, in some implementations, the method 300 may include additional blocks, fewer blocks, different blocks, or differently arranged blocks than those depicted in FIG. 3. Additionally, or alternatively, two or more of the blocks of the method 300 may be performed in parallel. The method 300 is an example of one method that may be performed by one or more devices described herein. These one or more devices may perform or may be configured to perform one or more other methods based on operations described herein.

In some implementations, a memory device includes one or more components configured to: receive, from a host system, a first indication of one or more memory address ranges for which accesses are to be monitored and a second indication of a memory unit size to be used by the memory device to monitor accesses to the one or more memory address ranges; determine one or more memory units associated with the one or more memory address ranges; determine, using an access counter for each memory unit, of the one or more memory units, a quantity of accesses to that memory unit during a monitoring period; determine that a corresponding access counter for each memory unit, of a subset of the one or more memory units, satisfies an access threshold; and add an identifier of, and an indication of the corresponding access counter for, each memory unit, of the subset of the one or more memory units, to a data structure based on determining that the corresponding access counter for each memory unit, of the subset of the one or more memory units, satisfies the access threshold.

In some implementations, a method includes receiving, by a memory system from a host system, a first indication of one or more memory address ranges for which accesses are to be monitored and a second indication of a memory unit size to be used by the memory system to monitor accesses to the one or more memory address ranges; determining, by the memory system, one or more memory units associated with the one or more memory address ranges; determining, by the memory system and using an access counter for each memory unit, of the one or more memory units, a quantity of accesses to that memory unit during a monitoring period; determining, by the memory system, that a corresponding access counter for each memory unit, of a subset of the one or more memory units, satisfies an access threshold; and adding, by the memory system, an identifier of, and an indication of the corresponding access counter for, each memory unit, of the subset of the one or more memory units, to a data structure based on determining that the corresponding access counter for each memory unit, of the subset of the one or more memory units, satisfies the access threshold.

In some implementations, a compute express link (CXL) compliant memory device includes one or more components configured to: receive, from a host system, a first indication of one or more memory address ranges for which CXL.mem accesses are to be monitored and a second indication of a memory unit size to be used by the CXL compliant memory device to monitor CXL.mem accesses to the one or more memory address ranges; determine one or more memory units associated with the one or more memory address ranges; determine, using a hotness counter for each memory unit, of the one or more memory units, a quantity of CXL.mem accesses to that memory unit during an epoch; determine that a corresponding hotness counter for each memory unit, of a subset of the one or more memory units, satisfies a hotness threshold; and add an identifier of, and an indication of the corresponding hotness counter for, each memory unit, of the subset of the one or more memory units, to a hotlist based on determining that the corresponding hotness counter for each memory unit, of the subset of the one or more memory units, satisfies the hotness threshold.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
receive, from a host system, a first indication of one or more memory address ranges for which accesses are to be monitored and a second indication of a memory unit size to be used by the memory device to monitor accesses to the one or more memory address ranges;
determine one or more memory units associated with the one or more memory address ranges;
determine, using an access counter for each memory unit, of the one or more memory units, a quantity of accesses to that memory unit during a monitoring period;
determine that a corresponding access counter for each memory unit, of a subset of the one or more memory units, satisfies an access threshold; and
add an identifier of, and an indication of the corresponding access counter for, each memory unit, of the subset of the one or more memory units, to a data structure based on determining that the corresponding access counter for each memory unit, of the subset of the one or more memory units, satisfies the access threshold.

2. The memory device of claim 1, wherein the memory device is a compute express link (CXL) memory device, and wherein the accesses that are to be monitored are associated with CXL.mem requests.

3. The memory device of claim 1, wherein the one or more components are further configured to receive, from the host system, an indication of the access threshold.

4. The memory device of claim 1, wherein the one or more components are further configured to save a plurality of instances of the data structure.

5. The memory device of claim 1, wherein the one or more components are further configured to:
receive, from the host system, an indication that each access counter is to be reduced after the monitoring period; and
reduce each access counter based on receiving the indication that each access counter is to be reduced.

6. The memory device of claim 1, wherein the one or more components are further configured to indicate, to the host system and via an access monitoring unit register, capability information indicating one or more parameters associated with monitoring accesses to the one or more memory units.

7. The memory device of claim 6, wherein the capability information indicates at least one of:
whether monitoring accesses to the one or more memory units is supported by the memory device,
a maximum memory address range size supported by the memory device,
one or more types of accesses that can be monitored by the memory device,
a maximum monitoring period size supported by the memory device,
a minimum monitoring period size supported by the memory device,
a maximum data structure size supported by the memory device,
a type of data structure sorting supported by the memory device,
whether the memory device supports variable access counter sizes,
whether the memory device supports reducing access counters at an end of the monitoring period,
whether the memory device supports saving one or more instances of the data structure,
whether the memory device supports a reduction in a sampling rate associated with the access counters,
a data structure eviction policy supported by the memory device,
a maximum access threshold supported by the memory device,
a maximum access counter size supported by the memory device,
one or more memory unit sizes supported by the memory device,
one or more access counter reduction factors supported by the memory device, or
a maximum number of saved instances of the data structure supported by the memory device.

8. The memory device of claim 1, wherein the one or more components are further configured to receive, from the host system and via an access monitoring unit register, configuration information indicating one or more parameters associated with monitoring accesses to the one or more memory units.

9. The memory device of claim 8, wherein the configuration information indicates at least one of:
whether monitoring accesses to the one or more memory units is to be enabled,
one or more types of accesses that are to be monitored by the memory device,
a size of the access threshold,
a size of the data structure,
a type of data structure sorting to be used by the memory device,
whether the memory device is to save one or more instances of the data structure,
whether the memory device is to reduce access counters at an end of the monitoring period,
whether the memory device is to reduce access counters when indicated to do so by the host system,
whether the memory device is to reduce a sampling rate associated with access counters,
an access counter size to be used by the memory device,
the memory unit size to be used by the memory device,
a monitoring period size to be used by the memory device,
a type of reduction factor to be used to reduce access counters at the end of the monitoring period,
control information associated with at least of one resetting a monitoring operation or reducing access counters, or
the one or more memory address ranges for which the accesses are to be monitored.

10. The memory device of claim 1, wherein the one or more components are further configured to indicate, to the host system and via an access monitoring unit register, at least one of:
a quantity of a plurality of instances of the data structure that have been saved by the memory device, or
an indication of each instance of the data structure, of the plurality of instances of the data structure that have been saved by the memory device.

11. A method, comprising:
receiving, by a memory system from a host system, a first indication of one or more memory address ranges for which accesses are to be monitored and a second indication of a memory unit size to be used by the memory system to monitor accesses to the one or more memory address ranges;
determining, by the memory system, one or more memory units associated with the one or more memory address ranges;
determining, by the memory system and using an access counter for each memory unit, of the one or more memory units, a quantity of accesses to that memory unit during a monitoring period;
determining, by the memory system, that a corresponding access counter for each memory unit, of a subset of the one or more memory units, satisfies an access threshold; and
adding, by the memory system, an identifier of, and an indication of the corresponding access counter for, each memory unit, of the subset of the one or more memory units, to a data structure based on determining that the corresponding access counter for each memory unit, of the subset of the one or more memory units, satisfies the access threshold.

12. The method of claim 11, wherein the memory system is a compute express link (CXL) memory system, and wherein the accesses that are to be monitored are associated with CXL.mem requests.

13. The method of claim 11, further comprising indicating, by the memory system to the host system and via an access monitoring unit register, capability information indicating one or more parameters associated with monitoring accesses to the one or more memory units.

14. The method of claim 13, wherein the capability information indicates at least one of:
whether monitoring accesses to the one or more memory units is supported by the memory system,
a maximum memory address range size supported by the memory system,
one or more types of accesses that can be monitored by the memory system,
a maximum monitoring period size supported by the memory system,
a minimum monitoring period size supported by the memory system,
a maximum data structure size supported by the memory system,
a type of data structure sorting supported by the memory system,
whether the memory system supports variable access counter sizes,
whether the memory system supports reducing access counters at an end of the monitoring period,
whether the memory system supports saving one or more instances of the data structure,
whether the memory system supports a reduction in a sampling rate associated with the access counters,
a data structure eviction policy supported by the memory system,
a maximum access threshold supported by the memory system,
a maximum access counter size supported by the memory system,
one or more memory unit sizes supported by the memory system,
one or more access counter reduction factors supported by the memory system, or
a maximum number of saved instances of the data structure supported by the memory system.

15. The method of claim 11, further comprising receiving, by the memory system from the host system and via an access monitoring unit register, configuration information indicating one or more parameters associated with monitoring accesses to the one or more memory units.

16. The method of claim 15, wherein the configuration information indicates at least one of:
whether monitoring accesses to the one or more memory units is to be enabled,
one or more types of accesses that are to be monitored by the memory system,
a size of the access threshold,
a size of the data structure,
a type of data structure sorting to be used by the memory system,
whether the memory system is to save one or more instances of the data structure,
whether the memory system is to reduce access counters at an end of the monitoring period,
whether the memory system is to reduce access counters when indicated to do so by the host system,
whether the memory system is to reduce a sampling rate associated with access counters,
an access counter size to be used by the memory system,
the memory unit size to be used by the memory system,
a monitoring period size to be used by the memory system,
a type of reduction factor to be used to reduce access counters at the end of the monitoring period,
control information associated with at least of one resetting a monitoring operation or reducing access counters, or
the one or more memory address ranges for which the accesses are to be monitored.

17. The method of claim 11, further comprising indicating, by the memory system to the host system and via an access monitoring unit register, at least one of:
a quantity of a plurality of instances of the data structure that have been saved by the memory system, or
an indication of each instance of the data structure, of the plurality of instances of the data structure that have been saved by the memory system.

18. A compute express link (CXL) compliant memory device, comprising:
one or more components configured to:
receive, from a host system, a first indication of one or more memory address ranges for which CXL.mem accesses are to be monitored and a second indication of a memory unit size to be used by the CXL compliant memory device to monitor CXL.mem accesses to the one or more memory address ranges;
determine one or more memory units associated with the one or more memory address ranges;
determine, using a hotness counter for each memory unit, of the one or more memory units, a quantity of CXL.mem accesses to that memory unit during an epoch;
determine that a corresponding hotness counter for each memory unit, of a subset of the one or more memory units, satisfies a hotness threshold; and
add an identifier of, and an indication of the corresponding hotness counter for, each memory unit, of the subset of the one or more memory units, to a hotlist based on determining that the corresponding hotness counter for each memory unit, of the subset of the one or more memory units, satisfies the hotness threshold.

19. The CXL compliant memory device of claim 18, wherein the one or more components are further configured to indicate, to the host system and via a hotness monitoring unit register, capability information indicating one or more parameters associated with monitoring CXL.mem accesses to the one or more memory units.

20. The CXL compliant memory device of claim 18, wherein the one or more components are further configured to receive, from the host system and via a hotness monitoring unit register, configuration information indicating one or more parameters associated with monitoring CXL.mem accesses to the one or more memory units.
